(19) United States
(12) Patent Application Publication
(10) Pub. No.: US 2008/0060039 A1
(43) Pub. Date: Mar. 6, 2008

(54) Apparatus and method of storing broadcasting service

(75) Inventors: Kwang-hyuk Kim, Seoul (KR); Keum-yong Oh, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/650,452

(22) Filed: Jan. 8, 2007

(30) Foreign Application Priority Data
Sep. 6, 2006 (KR) 10-2006-0085891

(51) Int. Cl. H04N 7/173

(52) U.S. Cl. 725/115; 725/93; 725/94

(57) ABSTRACT

Provided are an apparatus and method of storing a broadcasting service. The apparatus and method are capable of moving or copying a broadcasting service stored in a storage device to another storage device and using the moved or copied broadcasting service. The apparatus includes a broadcasting reception unit receiving a broadcasting signal containing a broadcasting service; and a recording manager controlling the storing of the broadcasting service, wherein the recording manager controls the broadcasting service stored in a media storage volume to be moved or copied to another media storage volume and manages recording information indicating a media storage volume in which the broadcasting service is stored.

### BACKGROUND OF THE INVENTION

This application claims the priority of Korean Patent Application No. 10-2006-0085891, filed on Sep. 6, 2006, in the Korean Intellectual Property Office, the disclosure of which is incorporated herein in its entirety by reference.

1. Field of the Invention

The present invention relates to an apparatus for storing a broadcasting service, and more particularly, to an apparatus and method of storing a broadcasting service, the apparatus and method capable of moving or copying a broadcasting service stored in a storage device to another storage device and using the moved or copied broadcasting service.

2. Description of the Related Art

A broadcasting environment has evolved from a unilateral broadcasting environment in which broadcasting content is provided unilaterally, to a data broadcasting environment and then to an interactive broadcasting environment. In addition, broadcasting service users have become capable of storing desired broadcasting content at a desired time and using the stored broadcasting content.

Data broadcasting is a service of providing various information related to a broadcasting program, living information, Internet connection, electronic commerce, and interactive entertainment using a broadcasting network, such as a terrestrial, satellite or cable network, in addition to providing the broadcasting program. Conventional international data broadcasting standards include an open cable application platform (OCAP), an advanced common application platform (ACAP), and a multimedia home platform (MHP). In OCAP 1.0 profile OC-SP-OCSP1.0-I16-050803 (hereinafter, referred to as OCSP 116) and OC-SP-OCAP-DVR-I02-050524 (hereinafter, referred to as OCAP DVR I02), which are standards of the OCAP, an application program interface (API) for storing recorded broadcasting data in a particular storage is provided and supported.

However, if the amount of the recorded broadcasting data increases and thus there is no more space left to store new broadcasting data in the storage, existing broadcasting data must be deleted. That is because the OCAP I16 standard or the OCAP DVR I02 standard provides an application programming interface (API) for storing media data received through a broadcasting signal in a particular storage but does not provide a method of moving or copying recorded broadcasting data to another storage. In other words, even if an additional storage is added to an apparatus for storing a broadcasting service, the apparatus must delete existing broadcasting data in order to store new broadcasting data since the conventional standards do not provide a function for moving or copying recorded broadcasting data to the additional storage.

### SUMMARY OF THE INVENTION

Exemplary embodiments of the present invention provide an apparatus and method of storing a broadcasting service, the apparatus and method being capable of moving or copying a broadcasting service stored in a storage device to another storage device or another storage location.

Exemplary embodiments of the present invention also provide an apparatus and method of storing a broadcasting service, the apparatus and method capable of managing and reproducing a broadcasting service moved or copied from a storage device to another storage device or another storage location.

According to an aspect of the present invention, there is provided an apparatus for storing a broadcasting service. The apparatus includes a broadcasting reception unit receiving a broadcasting signal containing a broadcasting service; and a recording manager controlling the storing of the broadcasting service, wherein the recording manager controls the broadcasting service stored in a media storage volume to be moved or copied to another media storage volume and manages recording information indicating a media storage volume in which the broadcasting service is stored.

The apparatus may further include a storage unit to which a media storage volume is allocated and which stores the broadcasting service in the allocated media storage volume.

The apparatus may further include a storage manager managing information regarding the storage space of a storage device in which the broadcasting service is stored.

The recording manager may further receive information regarding the storage space of the storage device from the storage device which stores the broadcasting service and control the storing of the broadcasting service in the storage device based on the received information.

The other media storage volume may be allocated to the storage unit.

The other media storage volume may be allocated to another storage device which is connected to the apparatus, and the storage manager may also manage information regarding the storage space of the other storage device.

The recording manager may update the recording information when the broadcasting service is moved or copied to the other media storage volume.

The recording manager may determine whether the broadcasting service can be stored in the storage device using the information regarding the storage space of the storage device.

The apparatus may further include a user interface unit receiving a user input signal and transmitting the received user input signal to the recording manager, wherein the recording manager controls the stored broadcasting service to be moved or copied to the other media storage volume based on the user input signal.

The recording manager may control the stored broadcasting service to be moved or copied to the other media storage volume based on signaling information of an application for a broadcasting service.

The recording manager may identify whether the recording manager has the authority to move or copy the broadcasting service.

According to another aspect of the present invention, there is provided a method of storing a broadcasting service. The method includes moving or copying a broadcasting service stored in a media storage volume to another media storage medium; and managing recording information indicating a media storage volume in which the broadcasting service is stored.

According to another aspect of the present invention, there is provided a computer-readable recording medium on which a program for executing a method of storing a broadcasting service is recorded, the method including moving or copying a broadcasting service stored in a media storage volume to another media storage medium; and managing recording information indicating a media storage medium in which the broadcasting service is stored.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an apparatus for storing a broadcasting service according to an exemplary embodiment of the present invention;

FIG. 2 is a flowchart illustrating a method of storing a broadcasting service according to an exemplary embodiment of the present invention;

FIG. 3 is a flowchart illustrating a process of moving a broadcasting service stored in a media storage volume to another media storage volume according to an exemplary embodiment of the present invention; and

FIG. 4 is a flowchart illustrating a process of copying a broadcasting service stored in a media storage volume to another media storage volume according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the exemplary embodiments set forth therein; rather, these exemplary embodiments are provided so that this disclosure will be thorough and complete, and will fully convey the concept of the invention to those skilled in the art.

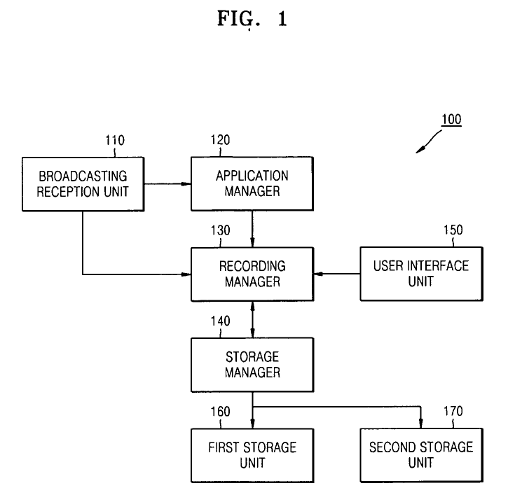

FIG. 1 is a block diagram of an apparatus 100 for storing a broadcasting service according to an embodiment of the present invention. Referring to FIG. 1, the apparatus 100 includes a broadcasting reception unit 110, an application manager 120, a recording manager 130, a storage manager 140, a user interface unit 150, a first storage unit 160, and a second storage unit 170.

The broadcasting reception unit 110 receives a broadcasting signal through a broadcasting network, such as a terrestrial, satellite, or cable network, and generates a discrete broadcasting service. The broadcasting reception unit 110 may process the broadcasting signal based on a transmission path of the broadcast signal and broadcasting content. In the present specification, a broadcasting service includes a broadcasting program composed of audio and/or video data and a broadcasting program including a media file, such as an audio and/or video file, and an application related to the media file.

The application manager 120 loads and executes an application using signalling information of the application, such as a digital video recorder (DVR) application, which includes information regarding an eXtended application information table (XAIT) or an application information table (AIT), and manages a life cycle of the application. Here, applications are classified into a bound application which is bound or related to a particular broadcasting service and an unbound application which is not bound to a broadcasting service. The AIT provides information regarding an activation state of a bound application, and the XAIT is a table for launching and managing an unbound application.

The recording manager 130 is controlled by the application executed by the application manager 120. In addition, the recording manager 130 controls the storing of a reserved broadcasting service by designating a schedule based on a user input signal of the user interface unit 150. The recording manager 130 performs what is recorded in OCAP DVR Storage API of Annex E of OCAP I02.

According to an exemplary embodiment of the present invention, the recording manager 130 may control a broadcasting service to be automatically stored whenever a predetermined event occurs, without a storage request of a user. A method of automatically storing a broadcasting service whenever an event occurs may be preset when the apparatus 100 is released. Therefore, the user may use an initial setting. Alternatively, the user may change the initial setting to a new setting in which the user is asked whether to store or delete a broadcasting service whenever an event occurs.

The storage manager 140 manages information regarding the storage space (hereinafter, referred to as storage space information) of a physical storage device, such as the first storage unit 160 or the second storage unit 170, which is connected to the apparatus 100. In other words, when a broadcasting service is stored in a physical storage device such as a hard disk drive (HDD), the storage manager 140 determines the size and location of the broadcasting service that is to be stored in the physical storage device and, after the broadcasting service is stored, manages a stored space and a storable space.

Therefore, the recording manager 130 manages the recording of a broadcasting service with reference to the storage space information which is managed by the storage manager 140. The storage manager 140 performs what is written in Annex V OCAP 1.0 Storage API of OCAP I16.

According to another exemplary embodiment of the present invention, the storage manager 140 may not be included in the apparatus 100. Instead, the recording manager 130 may request each storage device for storage space information, receive the requested information from each storage device, analyze the received information, and designate a storage device to store a broadcasting service.

The first storage unit 160 is generally an HDD and is a storage which may be included in a conventional apparatus for storing a broadcasting service, such as a DVR. In the present specification, the second storage unit 170 is a storage device which may be additionally included in the apparatus 100 or be connected to the apparatus 100 and used accordingly.

The apparatus 100 may not include a storage device such as the first storage unit 160. In this case, the apparatus 100 may store a broadcasting service in an external storage device which is connected to the apparatus 100 and which can transmit or receive data to/from the apparatus 100.

OCAP I16 defines a storage proxy as a concept corresponding to a physical storage device, such as an HDD. In the OCAP DVR I02 standard, a media storage option is provided in order to secure a space in each storage proxy where a media file can be recorded and stored. A media storage volume in which a media file is actually stored is generated using each media storage option. The media storage volume indicates a location at which a media file or a broadcasting service is actually stored.

In other words, a physical storage device includes a media storage option, and the media storage option generates a plurality of media storage volumes that record real audio and video (AV) data and applications. Each broadcasting program that is recorded exists as a logical unit called a ‘service.’ In addition, each broadcasting program is recorded on a media storage volume, together with a unique ID or name.

Generally, a predetermined size is allocated to a media storage volume. Therefore, recorded content cannot be stored in the media storage volume in excess of the predetermined size and in excess of a storage size of the storage, which is a physical HDD size. Therefore, as described above, if the capacity of a broadcasting service that is to be newly recorded exceeds the storage capacity of an OCAP/MHP/ACAP-based apparatus for storing a broadcasting service, a previously recorded broadcasting service has to be deleted in order to secure a storage space for the new broadcasting service.

However, according to an exemplary embodiment of the present invention, the recording manager 130 may move or copy and record a broadcasting service stored in a media storage volume of the first storage unit 160 to another media storage volume of the first storage unit 160 or another media storage volume of the second storage unit 170. The recording manager 130 controls the stored broadcasting service to be moved or copied to another media storage volume with reference to the storage space information, which is managed by the storage manager 140, of a storage unit to which the stored broadcasting service is to be moved or copied.

The recording manager 130 manages a media storage volume in which a broadcasting service is stored, that is, manages recording information indicating a location at which a broadcasting service is stored. If a broadcasting service is moved or copied to another media storage volume, the recording manager 130 updates the recording information. The recording manager 130 includes a database which contains recording information of each stored broadcasting service and may manage the recording information as a way to update the database.

Since the recording manager 130 manages recording information in this way, location information of a broadcasting service which is moved or copied to another storage device can be provided when the broadcasting service is moved or copied from a storage device to another storage device. For example, a user interface screen including location information of a broadcasting service may be displayed on a display device (not shown), which may be included in the apparatus 100, and thus be provided to a user so that the user can manage and reproduce the broadcasting service.

A media storage volume to which a broadcasting service is to be moved or copied may be allocated by the recording manager 130 to the first storage unit 160. Alternatively, the media storage volume to which a broadcasting service is to be moved or copied may be allocated to the second storage unit 170, which is different from the first storage unit 160. In this case, the storage manager 140 also manages storage space information of the second storage unit 170.

Before storing a broadcasting service in the first storage unit 160 or the second storage unit 170, the recording manager 130 determines whether the broadcasting service can be stored in the first storage unit 160 or the second storage unit 170 based on the storage space information managed by the storage manager 140. If determining that the broadcasting service can be stored, the recording manager 130 stores the broadcasting service in the first storage unit 160 or the second storage unit 170.

In addition, the recording manager 130 determines whether it has authority to move or copy the broadcasting service. If determining that it has authority to move or copy the broadcasting service, the recording manager 130 stores the broadcasting service. Whether the broadcasting service can be moved or copied can be determined based on writing permission information included in signalling information of an application.

The user interface unit 150 receives a user input signal and transmits the received user input signal to the recording manager 130. Then, the recording manager 130 can control a stored broadcasting service to be moved or copied to another media storage volume based on the user input signal requesting the movement or copying of the stored broadcasting service.

Based on the signalling information of the application for a broadcasting service, the recording manager 130 may control the stored broadcasting service to be moved or copied to another media storage volume. For example, when a newly received broadcasting service cannot be stored in a current storage device, the signalling information of the application includes information which can control the recording manager 130 to move a broadcasting service stored in the current storage device to another storage device, which is connected to the apparatus 100 and has a sufficient storage space, and to continuously store the newly received broadcasting service.

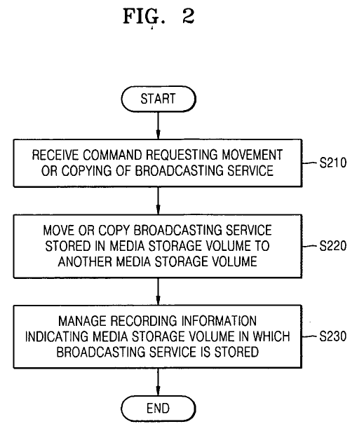

FIG. 2 is a flowchart illustrating a method of storing a broadcasting service according to an exemplary embodiment of the present invention.

Referring to FIG. 2, in operation S210, a command requesting the movement or copying of a broadcasting service is received. The command requesting the movement or copying of the broadcasting service may be generated based on a user input signal, signalling information of an application for a broadcasting service, or storage related information which is preset in an apparatus for storing a broadcasting service.

In operation S220, the broadcasting service stored in a media storage volume is moved or copied to another media storage volume. In this case, another media storage volume may be a media storage volume allocated to a storage device in which the broadcasting service is currently stored. Alternatively, another media storage volume may be a media storage volume allocated to another storage device, which is different from the storage device in which the broadcasting service is currently stored.

In operation S230, recording information indicating a media storage volume in which the broadcasting service is stored is managed. Since the recording information is managed, even if a broadcasting service is moved or copied from a storage device to another storage device, the broadcasting service moved or copied to another storage device can be managed and reproduced.

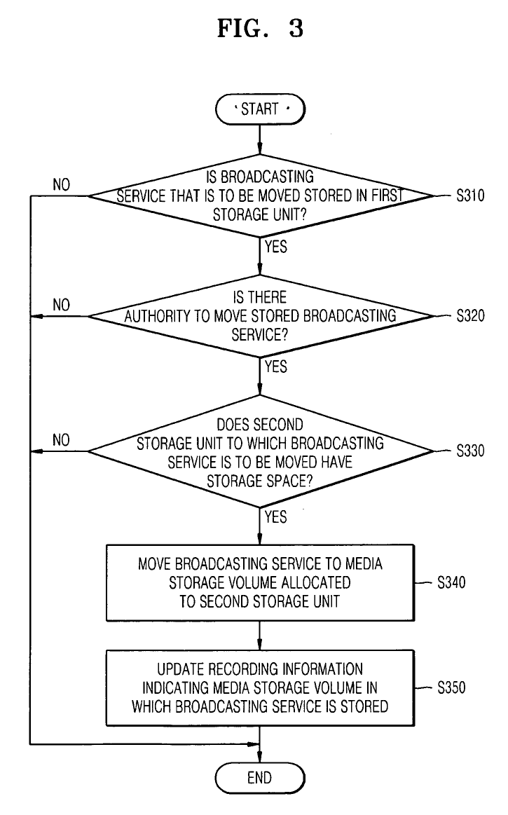

FIG. 3 is a flowchart illustrating a process of moving a broadcasting service stored in a media storage volume to another media storage volume according to an exemplary embodiment of the present invention.

Referring to FIG. 3, it is determined whether a broadcasting service corresponding to a movement command is stored in the first storage unit 160. In operation S320, if there is a broadcasting service to be moved, it is determined whether there is authority to move the stored broadcasting service.

In operation S330, if it is determined that there is authority to move the stored broadcasting service, it is determined whether the second storage unit 170 to which the broadcasting service is to be moved has a storage space. If it is determined in operation S330 that the second storage unit 170 has the storage space, the broadcasting service is moved and stored to/in a media storage volume allocated to the second storage unit 170 in operation S340.

In operation S340, if the broadcasting service is moved to the media storage volume of the second storage unit 170, recording information indicating a media storage volume in which a broadcasting service is stored is updated in operation S350. In other words, the recording information is updated in order to reflect the fact that the broadcasting service is stored in the media storage volume of the second storage unit 170.

The operation of moving a broadcasting service can be initiated in the following case. That is, when the storage space of the first storage unit 160 included in the apparatus 100 is insufficient to store a new broadcasting service, the operation of moving an existing broadcasting service to the second storage unit 170 connected to the apparatus 100 is initiated. Therefore, the new broadcasting service can be stored in the storage space of the first storage unit 160 which is secured after the existing broadcasting service is moved to the second storage unit 170.

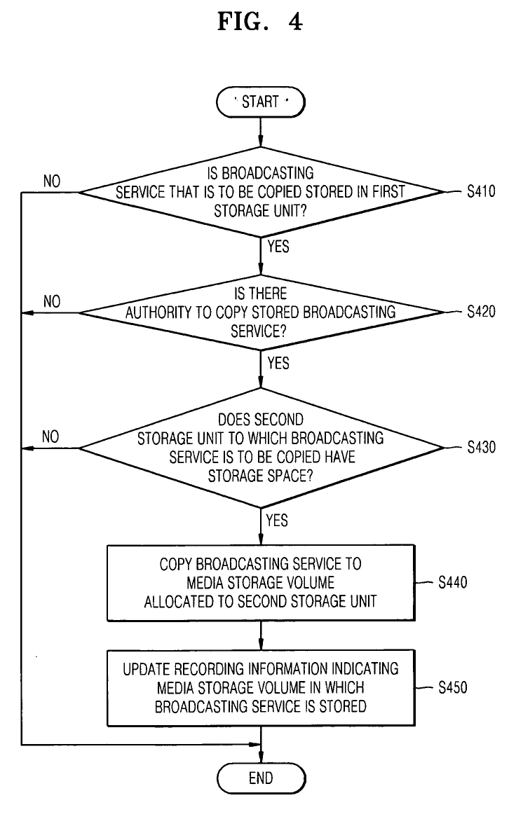

FIG. 4 is a flowchart illustrating a process of copying a broadcasting service stored in a media storage volume to another media storage volume according to an embodiment of the present invention.

Referring to FIG. 4, it is determined whether a broadcasting service corresponding to a copy command is stored in the first storage unit 160. In operation S420, if it is determined that the broadcasting service is stored in the first storage unit 160, it is determined whether there is authority to copy the stored broadcasting service.

In operation S430, if it is determined that there is authority to copy the stored broadcasting service, it is determined whether the second storage unit 170 to which the broadcasting service is to be copied has a storage space. If it is determined in operation S430 that the second storage unit 170 has the storage space, the broadcasting service is copied to a media storage volume allocated to the second storage unit 170 in operation S440.

In operation S440, if the broadcasting service is copied to the media storage volume of the second storage unit 170, recording information indicating a media storage volume in which a broadcasting service is stored is updated in operation S450. In other words, the recording information is updated in order to reflect the fact that the broadcasting service is stored in the media storage volumes of the first storage unit 160 and the second storage unit 170, respectively.

The present invention can also be implemented as computer-readable code on a computer-readable recording medium. Also, code and code segments for accomplishing the present invention can be easily construed by programmers skilled in the art to which exemplary embodiments of the present invention pertain.

The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet).

The computer-readable recording medium can also be distributed over network-coupled computer systems so that the computer-readable code is stored and executed in a distributed fashion.

As described above, an apparatus and method of providing a broadcasting service according to exemplary embodiments of the present invention can move or copy a broadcasting service from a storage device to another storage device.

In addition, the apparatus and method can manage recording information. Therefore, even if a broadcasting service is moved or copied from a storage device to another storage device, the apparatus and method can reproduce the broadcasting service that was moved or copied to another storage device.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for storing a broadcasting service, the apparatus comprising:
a broadcasting reception unit which receives a broadcasting signal containing the broadcasting service; and
a recording manager which controls the storing of the broadcasting service,
wherein the recording manager controls the broadcasting service stored in a media storage volume to be one of moved and copied to another media storage volume and manages recording information indicating a media storage volume in which the broadcasting service is stored.

2. The apparatus of claim 1, further comprising a storage unit to which the media storage volume is allocated and which stores the broadcasting service in an allocated media storage volume.

3. The apparatus of claim 1, further comprising a storage manager which manages information regarding first storage space of a storage device in which the broadcasting service is stored.

4. The apparatus of claim 1, wherein the recording manager receives information regarding storage space of a storage device which stores the broadcasting service and controls the storing of the broadcasting service in the storage device based on the received information.

5. The apparatus of claim 2, wherein the another media storage volume is allocated to the storage unit.

6. The apparatus of claim 3, wherein the another media storage volume is allocated to another storage device which is connected to the apparatus, and the storage manager also manages information regarding second storage space of the another storage device.

7. The apparatus of claim 1, wherein the recording manager updates the recording information when the broadcasting service is one of moved and copied to the another media storage volume.

8. The apparatus of claim 1, wherein the recording manager determines whether the broadcasting service can be stored in a storage device using information regarding storage space of the storage device.

9. The apparatus of claim 1, further comprising a user interface unit which receives a user input signal and transmits the received user input signal to the recording manager, wherein the recording manager controls the stored broadcasting service to be one of moved and copied to the another media storage volume based on the user input signal.

10. The apparatus of claim 1, wherein the recording manager controls the stored broadcasting service to be one of moved and copied to the another media storage volume based on signaling information of an application for the broadcasting service.

11. The apparatus of claim 1, wherein the recording manager identifies whether the recording manager has authority to one of move and copy the broadcasting service.

12. A method of storing a broadcasting service, the method comprising:
one of moving and copying a broadcasting service stored in a media storage volume to another media storage volume; and
managing recording information indicating a media storage volume in which the broadcasting service is stored.

13. The method of claim 12, wherein the one of moving and copying of the broadcasting service is performed based on preset information in relation to a broadcasting service storage.

14. The method of claim 12, wherein the another media storage volume is allocated to a storage device in which the broadcasting service is currently stored.

15. The method of claim 12, wherein the another media storage volume is allocated to another storage device which is different from the storage device in which the broadcasting service is currently stored.

16. The method of claim 12, wherein the managing of the recording information further comprises updating the recording information when the broadcasting service is one of moved and copied to the another media storage volume.

17. The method of claim 12, further comprising determining whether there is a storage space to which the broadcasting service can be one of moved and copied.

18. The method of claim 12, further comprising receiving a user input signal, wherein the one of moving and copying of the broadcasting service is performed in response to a command requesting one of moving and copying of the broadcasting service, the command being generated based on the user input signal.

19. The method of claim 12, wherein the one of the moving and copying of the broadcasting service is based on signaling information of an application for a broadcasting service.

20. The method of claim 12, further comprising identifying whether there is authority to one of move and copy the broadcasting service.

21. A computer-readable recording medium on which a program for executing a method of storing a broadcasting service is recorded, the method comprising:
one of moving and copying a broadcasting service stored in a media storage volume to another media storage volume; and
managing recording information indicating a media storage volume in which the broadcasting service is stored.
